(19) United States
(12) Patent Application Publication
(10) Pub. No.: US 2007/0167081 A1
(43) Pub. Date: Jul. 19, 2007

(54) Modular multi configuration standardized bus computer system

(76) Inventor: David Edelson, North Bergen, NJ (US)

Correspondence Address: HOFFMANN & BARON, LLP, 6900 JERICHO TURNPIKE, SYOSSET, NY, 11791, US

(21) Appl. No.: 11/333,083

(22) Filed: Jan. 17, 2006

(51) Int. Cl. H01R 33/00

(52) U.S. Cl. 439/638

(57) ABSTRACT

A modular computer system comprising, a CPU module housed in a standardized container also having a central data communications hub and a central data communications bus, and power module housed in a standardized container, operatively connected to the CPU module, a plurality connectors operatively attached to the central data communications hub through the central data communications bus, a plurality of standardized module containers each housing a computer peripheral device linked to the plurality of connectors operatively attached to the central data communications hub.

### BACKGROUND OF THE INVENTION

1. Field of the Invention

The present invention relates to the field of a personal computer; more particularly, the present invention relates to a modular computer system and components that can be configured through a common communications bus to be configured in various ways, and further to provide a low cost platform that will easily enable the use of computer components.

2. Description of Related Art

Generally, the types of personal computers can be classified into desktop personal computers, notebook personal computers, pen-based personal computers, etc. Each type of personal computers has its own advantages but may suffer some disadvantages. For example, a desktop personal computer is easy to upgrade but inconvenient in carrying form place to place. On the contrary, a notebook personal computer is designed for high portability but suffers in upgrading. As a result, users have to purchase different types of personal computers for different purposes.

Once a particular computer is purchased it is difficult if not impossible to change the configuration of the computer and therefore may limit the user's options with respect to function and use of the computer. For example if a computer was not originally configured with an optical drive capable of writing data to a cd or dvd, the user will need to have the necessary optical drive installed. This type of upgrade may be beyond the skill of the typical home user, and therefore is an impediment to the user's ability to perform needed or desired tasks.

In addition, while desktop computers are easily upgradeable by one having sufficient skill, the typical home user is usually unable to make even simple upgrades and therefore, may purchase a new computer instead of upgrading a computer that has not reached the end of its useful life, or needs to have a skilled technician perform the upgrade tasks. Even in the case where the home user can make the required upgrade, the user may retain the replaced components that remain functioning, but are no longer suited for the user's purpose. In either circumstance when upgrades are made many components are discarded that may still have useful life. Discarding of components that are still operational, but no longer serve the needs of a particular user is wasteful both economically as well as environmentally. The continued use of serviceable components is therefore desirable as it can save a user money but also serves the highly desirable goals of recycling.

Therefore, there is a need for a personal computer that can be easily configured and upgraded by a typical home user and which provides a low cost platform for the utilization of a wide variety of new and or used computer components.

### SUMMARY OF THE INVENTION

The general objective of the present invention is to provide a user configurable modular personal computer that can be easily upgraded and configured by the user, and to provide a easily upgradeable platform can a user can modify and adapt to a number of uses and functions.

Another objective of the present invention is to provide a user with a personal computers or associated computer devices thereby eliminating the need to purchase different types of personal computers for different purposes. By adding or changing the modules, a user can easily achieve the purpose of upgrading or modifying a computer.

Yet another object of the present invention is to make available a low cost modular computer that will provide users with a platform to utilize both new and used components. Specifically in the case of used components, the modular personal computer can be easily built and configured using underutilized components.

In keeping with the objects of the present invention there is therefore provided a modular computer system comprising, a CPU module housed in a standardized container also having a central data communications hub and a central data communications bus, and power module housed in a standardized container, operatively connected to the CPU module, a plurality connectors operatively attached to the central data communications hub through the central data communications bus, a plurality of standardized module containers each housing a computer peripheral device linked to the plurality of connectors operatively attached to the central data communications hub.

Other objectives, advantages, and novel features of the invention will become more apparent from the following detailed description when taken in conjunction with the accompanying drawings.

### BRIEF DESCRIPTION OF THE DRAWINGS

FIG. 1 is a front perspective view of the preferred embodiment in FIG. 1.

FIG. 2 is an exploded perspective view of a preferred embodiment in accordance with the present invention.

FIG. 3 is a block diagram is shown illustrating the connection of a data transmission hub.

FIG. 4 is a bottom perspective view of an individual modular component of a preferred embodiment of the present invention.

FIG. 5 is a top interior view of an individual modular component of a preferred embodiment of the present invention.

### DETAILED DESCRIPTION OF PREFERRED EMBODIMENT

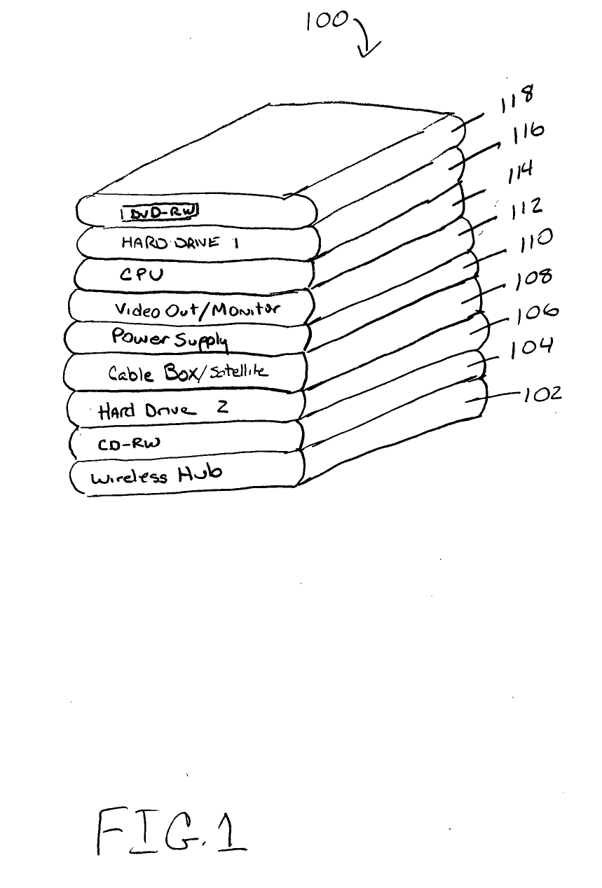

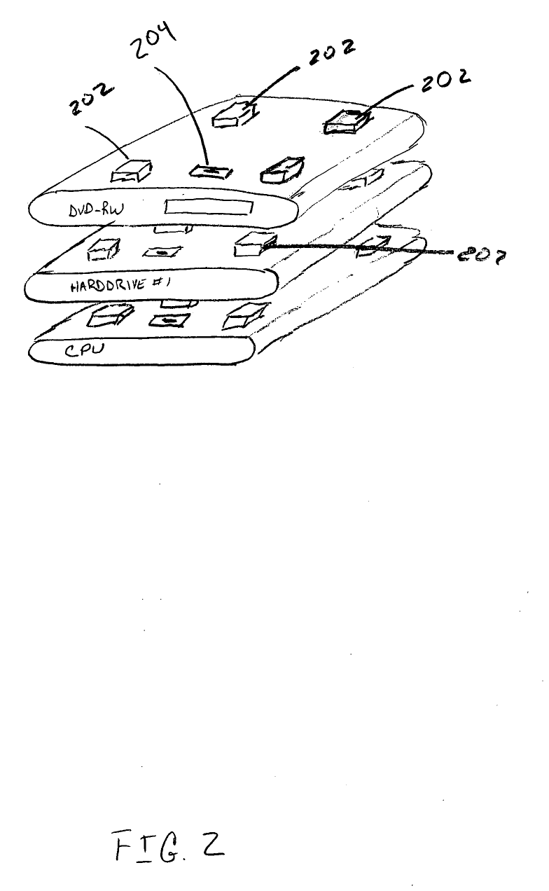

Referring to FIG. 1 and FIG. 2, a preferred embodiment of the present invention comprises a modular system of computer components housed in similarly sized and shaped containers.

Each container may include a connector for connecting the component contained therein to a common bus as well as components for mechanically linking each modular container to another.

Turning again to FIG. 1, there is shown a modular computer system according to the present invention having in this exemplary embodiment, nine separate modular containers. The containers shown and described are meant to be exemplary only and are not limiting as to the number or modules or the components that may be contained therein. Generally, the shape of each module is preferably a flat box like container. The specification of the length, width and other exterior characteristics for each module is determined so that a module may be readily mounted with another module.

In this exemplary embodiment, the modular computer 100 includes a wireless hub 102; a CD-RW 104, which is an optical read/write compact disc drive; a hard drive #2 106, which is a storage medium for storing applications and data; a cable box or satellite tuner card 108; a power supply 110; a video card 112; the CPU 114; a hard drive #1 116 and a DVD-RW, 118 which is an optical read/write digital video disc drive. According to the present invention the various components depicted can be attached in any order from top to bottom or may alternately be combined in other configurations. The modular computer according to the present invention can be configured in various ways depending on the needs of the user. As shown in FIG. 1, the module containers can be stacked, but the configuration is not limited to a single stack configuration and may be configured in two or three stack units for example. In addition, as with a prior art home computer system, The modular computer according to the present invention may also include a display monitor and input/output devices such as a keyboard, mouse, printers and speakers connected in the manner known in the art.

The display device may be a stand alone LCD or CRT display device operatively connected to the video card module 112 using a standard connection known to one skilled in the art such as a SVGA or DVI connector. Likewise other input/output devices, such as a keyboard or mouse would be connected to the CPU 114 utilizing the standard connectors for those devices such as for example a PS/2 connector.

The hard drive container modules 106 and 116 are equipped with storage device such as the hard disk, floppy disk for providing data storage capability to the computer. There are connectors provided on the hard drive container module for electrically linking the hard drive container modules 106 and 116 to the CPU 114 and transmitting signals therebetween.

The CPU 114 containing a motherboard, (not shown) and power supply 110 is provided for controlling and powering up the modular computer. The CPU may be connected by way of the central bus to any other device or component module container utilizing a central communications and control bus to provide the capability of transmitting standard industry signals, such as for example ISA, PCI slots signals and USB signals, among the various modules. Preferably each module is provided with the appropriate connector for connecting to the CPU module 114. In a preferred embodiment, the CPU 114 of the present invention includes a USB hub for providing communications among the various components. Not shown in this view are connectors that are provided between each container module which are adapted for electrically connecting with other connectors located on each container module to provide electricity and transmit signals therebetween. Each container module provides a connector for affecting a link between each module to the CPU through the appropriate type connection and data bus, which according to the present invention is preferable a USB connection although is not limited to such data transmission standard and may include other data transmission bus connections known to one skilled in the art.

Turning to FIG. 2, there is shown an expanded view of the computer system according to the present invention. In the perspective view of FIG. 2, there is shown an exemplary computer system having a CPU 114, Hard Drive#1 116 and DVD-RW 104. As shown each module container includes protrusions 202 located on the top of the module containers, which cooperatively engage depressions in the underside of an adjacent module container for mechanically interlocking each of the module containers to each other to form a stable stacking arrangement. It should be noted that the size, shape and number of protrusions 202 can be altered in accordance with the present invention to produce modular container of variable interlocking design.

In addition, on the top of each module container there is a bus connector for electrically connecting modules and transmitting signals between modules and CPU 114. As previously stated such connector is preferable a USB connector but one skilled in the art could modify the bus to other known data transmission standards.

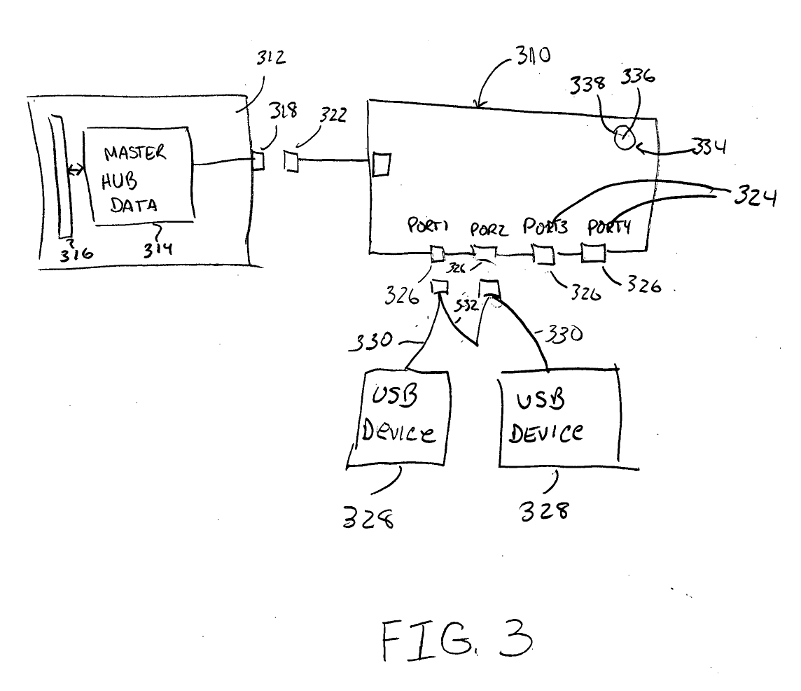

Turning now to FIG. 3, there is shown, a block diagram is shown illustrating the connection of a known USB hub 310 to a computer 312. The computer 312 has a USB interface which includes a master data hub 314 for receiving data from the USB hub 310. The master data hub 314 is coupled to the computer 312 via an internal bus 316 which provides a communication path between the master data hub and the computer. The master data hub 314 includes at least one USB connector 318. The USB hub 310 includes an upstream port 320 having a corresponding USB plug 322 which connects to the USB connector 318 of the master data hub 314.

The USB hub 310 also includes a plurality of downstream ports 324 having downstream USB connectors 326 to permit multiple modular devices 328, such as a keyboard, mouse, hard drives and optical drives to be coupled to the master data hub 314 through the USB hub 310. The peripheral devices 328 are each connected by a connection cable 330 to a USB connector 332 which mates with the downstream port connectors 326 of the USB hub 310.

The USB hub 310 typically contains connections for receiving power in two ways. First, the USB hub is bus powered for applications in which total current provided to the hub is less than approximately 500 mA. In bus powered applications, the USB hub receives power through the upstream port 320 from the USB plug 322 which contains separate positive and ground conductors. The USB hub can transfer a limited amount of current, approximately 100 mA, to each device through the downstream ports 324 via positive and ground conductors in the downstream connectors 326.

The USB hub 310 also includes a separate power connector 334 for receiving sufficient power to supply the higher current demands to the downstream ports 324 in high power applications. The power connector 334 includes a positive voltage conductor 336 and a ground conductor 338 for receiving DC voltage, preferably 5 volts, from a typical transformer (not shown) connected to an AC powered outlet (also not shown).

It should be further noted that the USB bus utilized in the present invention, need not be a separate component, but may utilize a communications port on the motherboard of the CPU itself. In that way, no separate device is needed as the motherboard would provide the necessary communications ports and bus, such as for example a USB bus.

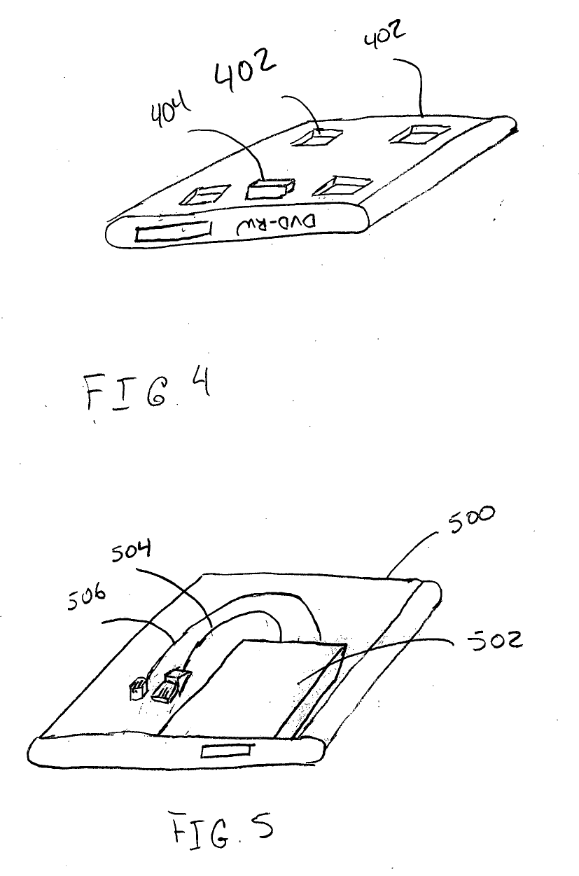

Turning now to FIG. 4, there is shown a bottom perspective view of one module container according to the present invention. In this view there are visible depressions 402 which cooperatively engage protrusions 202 for mechanically linking and interlocking the module containers.

Connector 404 for electrically connecting modules and transmitting signals between modules and CPU 114 is also shown. As previously stated such connector is preferably a USB connector. The top of each container module will have the complementary connectors to the connector locate on the bottom of each module container. In that way when the module containers are stacked, an electrical and data transmission path is created.

Turning now to FIG. 5, there is shown an interior view of a component module container 500, having in this exemplary depiction an optical drive 502 contained therein. According to the present invention, a standard computer device would be placed into a module container 500. The device would then be connected to connectors 204 or 404 housed in container 500. Container 500 could then be placed onto a CPU 114 container to electrically link the components by the interface of connectors 204 and 404. Furthermore, it should be noted that while an optical drive 502 is depicted in this example any such device could be installed utilizing the module container according to the present invention. For example a video display card could be connected to the motherboard through the CPU 114 container by providing the appropriate connector on the module containers. In addition, for other devices not having an internal USB connection, the module container can contain a link, such as a parallel to USB connection in order that the device can be linked by the USB connectors available on the module containers.

Although the present invention has been explained in relation to its preferred embodiment, it is to be understood that many other possible modifications and variations can be made without departing from the spirit and scope of the invention as hereinafter claimed.

What is claimed is:

1. A modular computer system comprising:
a CPU module housed in a standardized container also having a central data communications hub and a central data communications bus, and power module housed in a standardized container, operatively connected to said CPU module,
a plurality connectors operatively attached to said central data communications hub through said central data communications bus, a plurality of standardized module containers each housing a computer peripheral device linked to said plurality of connectors operatively attached to said central data communications hub.

2. A modular computer system as in claim 1, wherein said communications hub is a USB hub.

3. A modular computer system as in claim 1, wherein said communications bus is a USB bus.

4. A modular computer system as in claim 1, wherein said CPU module includes a motherboard.

5. A modular computer system as in claim 1, wherein said power module includes a power supply and switch.

6. A modular computer system as in claim 1, wherein said connectors operatively attached to said central data communications hub are USB connectors.

7. A modular computer system as in claim 1, wherein said connectors operatively attached to said central data communications hub are USB connectors

8. A modular computer system as in claim 1, wherein said connectors operatively attached to said central data communications hub are USB connectors

9. A modular computer system as in claim 1, wherein said standardized containers are mechanically linked together.

10. A modular computer system as in claim 9, wherein said standardized containers are mechanically linked together by cooperatively engagement of three dimensional patterns on said containers.

11. A modular computer system as in claim 9, wherein said computer peripheral device includes a memory storage device.

12. A modular computer system as in claim 9, wherein said computer peripheral device includes an optical media device.

13. A modular computer system as in claim 9, wherein said computer peripheral device includes a video display device.

14. A modular computer system kit comprising
a standardized container for housing a CPU module and a central communications hub and having a connector for linking to said central communications hub through a central communications bus, and a plurality of standardized container for housing computer components and having a connector for linking to said central communications hub.

15. The modular computer system kit of claim 14 wherein said standardized containers are mechanically linked together.

16. The modular computer system kit of claim 15 wherein said standardized containers are mechanically linked together by cooperatively engagement of three dimensional patterns on said containers.

17. The modular computer system kit of claim 14 wherein said communications hub is a USB hub.

18. The modular computer system kit of claim 14 wherein said connectors are USB connectors.

19. The modular computer system kit of claim 14 wherein said communications bus is a USB.

20. A modular computer system kit as in claim 14, wherein said computer component includes a memory storage device.

21. A modular computer system kit as in claim 14, wherein said computer component includes an optical media device.

22. A modular computer system kit as in claim 14, wherein said computer component includes a video display device.
